(19) United States
(12) Patent Application Publication
(10) Pub. No.: US 2006/0184369 A1
(43) Pub. Date: Aug. 17, 2006

(54) Voice activated instruction manual

(76) Inventor: Robin Levonas, Holmdel, NJ (US)

Correspondence Address: CARELLA, BYRNE, BAIN, GILFILLAN, CECCHI,;STEWART & OLSTEIN, 5 BECKER FARM ROAD, ROSELAND, NJ, 07068, US

(21) Appl. No.: 11/058,450

(22) Filed: Feb. 15, 2005

(51) Int. Cl. G10L 21/00

(52) U.S. Cl. 704/275

(57) ABSTRACT

A system is provided that allows a user to select digitized audio instructions from a computer via a wireless headset. The user activates the computer to deliver each instruction of a series of instructions on an as needed basis by delivering audio commands via the headset to the computer. Electrical signals from the computer are converted by the ear piece receiver into audible signals that can be followed by the user.

This invention relates to a voice interactive instruction system and to a tutorial method. More particularly, this invention relates to a system for a user to follow the steps of a recipe or set of assembly instructions on an audible basis.

As is known, various systems have been known that provide a tutorial method for teaching languages, such as described in U.S. Pat. No. 5,930,757. Typically, the known systems allow for an interactive exchange between the user and a computer wherein the user speaks set words or phrases and the computer responds by acknowledging that the spoken words are correct or not.

Instruction manuals have also been known that exist as a sequence of lines of text in printed format, or as online documents, that can be viewed on a computer terminal or other display device. One problem with this format is that the process of referring to the instruction manual and then returning to the activity that the manual is providing instruction for results in a break in concentration and, at times, a loss of focus.

Accordingly, it is an object of the invention to allow an individual making reference to an instruction manual to remain focused on the activity at hand while also providing a means to access the manual.

It is another object of the invention to allow a user to follow the instructions of an instruction manual on an audible basis in response to audible commands from the user.

It is another object of the invention to be able to follow a cooking or baking recipe audibly without a need to follow the instructions of the recipe visually.

Briefly, the invention provides a voice interactive instruction system that comprises a headset that is to be worn by a user and interfaces to a computer through wired or wireless means.

The headset is provided with a microphone for receiving a spoken command from the user, such as one of the commands “start” and “next” and for emitting an electrical signal to the computer where the signal is interpreted by the computer software.

The headset also includes a receiver, such as an earpiece, for receiving and converting electrical signals from the computer into audible signals that can be heard by the user.

The computer is provided with a memory for storing a series of digitized audio instructions, for example the steps from an instruction manual, the steps of a baking recipe or cooking recipe or the steps of an assembly process.

The computer also has a voice recognition program for receiving and recognizing a command signal from the microphone of the headset as well as a separate software application that integrates the voice recognition program and accesses the audio instructions in the memory. For example, the voice recognition program recognizes the command being spoken, e.g. “start” and delivers a corresponding signal to the software application that, in turn, selects the first of the audio instructions of the series in the memory.

The audio instructions are stored in computer memory in any one of many available standard formats, e.g. wave or midi format, to name a few. When a particular audio instruction is accessed for playback to the user, the audio file is converted to a format compatible with the playback device. For example, if using a wired headset, the stored audio instruction is converted back to its analog equivalent and then delivered as an electrical signal to the receiver of the headset. In the case of a wireless headset, the stored audio instruction would be digitally converted to a format suitable for transmission over the wireless channel, where it is then decoded at the receiving end of the wireless headset. The conversion is normally handled seamlessly by the operating system of the computer which will provide the appropriate conversion routine which is called by the application software. Those skilled in the art would be familiar with this process.

The software application operates to select the chronologically next audio instruction of the series in response to the spoken command “next”.

The interactive instruction system allows the user to speak a command such as “start” and the computer responds by emitting an electrical signal to the receiver of the headset to be converted to an audible signal to provide the first step of the audio instructions. When the user is ready for the next audio instruction, the user speaks the command “next”. The computer then responds with the next audio instruction in the form of an electrical signal that is converted in the receiver of the headset to an audible signal. In this way, the user is able to receive each audio instruction of the series at a time selected by the user. For example, if the user is interrupted, as by a telephone call, the user may complete the step in process, take the telephone call and thereafter return to the process and call for the next step. One advantage of the system is that the user will not inadvertently skip a step. In addition to this, the user will have the ability to repeat an instruction by saying, for example, “repeat” or “back” to replay the audio instruction or back up to any previous instruction. In a like manner, the user can skip instructions by saying, for example, “skip”, which will bypass an instruction and sequentially proceed to the next instruction following the instruction that has been skipped.

The invention also provides a tutorial method that comprises the steps of storing a series of digitized audio instructions in a computer in any conventional manner, converting a spoken command from the user into an electrical command signal and delivering the electrical command signal to the computer. Further, the method comprises the steps of selecting one of the audio instructions of the series in dependence on the command signal, converting the selected audio instruction into an electrical reply signal, delivering the electrical reply signal from the computer to a receiver on the user and converting the reply signal into an audio signal corresponding to the selected audio instructions for the user to follow.

These and other objects and advantages of the invention will become more apparent from the following detailed description taken in conjunction with the accompanying drawings wherein:

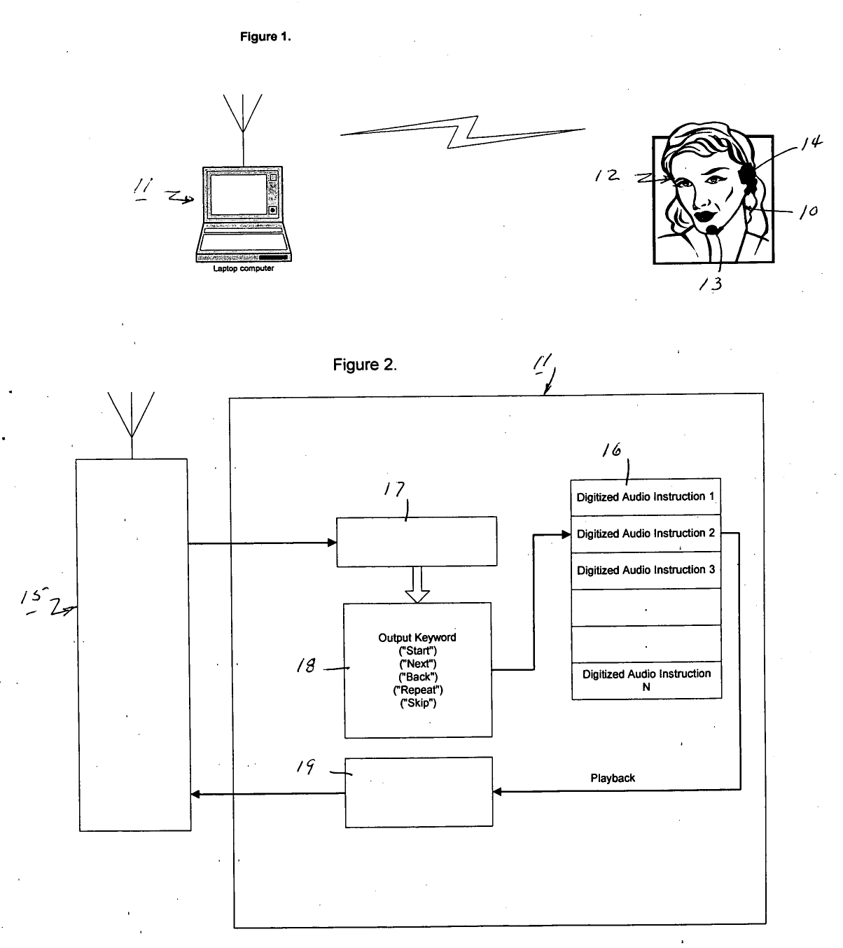

FIG. 1 schematically illustrates a system in accordance with the invention; and

FIG. 2 illustrates a schematic arrangement of the system in accordance with the invention.

Referring to FIG. 1, the interactive instruction system is comprised of a headset 10 and a computer 11.

The headset 10 is of a wired or wireless type (preferred) and provides an interface between a user 12 and the computer 11. The wireless headset 10 consists of a microphone 13 and a receiver in the form of an ear piece 14. Since modern wireless headsets usually transmit their signals in digital format, the headset 10 also provides the means to encode and decode the input and output audio signals in a manner consistent with their design and applicable standard, for example IEEE 802.15.

The microphone 13 of the headset 10 is of a type for receiving a spoken command from the user 12 and for emitting an electrical signal (the “command signal”) corresponding to the spoken audio signal (i.e. the spoken command) to the computer 11. The receiver 14 is of a type to receive electrical signals from the computer 11 and for converting the signals into audible signals. Any suitable ear piece type receiver may be used in this regard.

The computer 11 may be a desktop, laptop or pocket personal computer but may also be any other suitable device than a computer. For example, the computer may also be a central “server” which would supply support for one or more users.

Referring to FIG. 2, the computer 11 has an IEEE 802.15 compliant Bluetooth wireless transceiver 15 connected thereto to serve as one end of a wireless link to the headset 10. The computer 11 also has a memory 16 for storing a series of digitized audio instructions. In this respect, the series or sequence of audio instructions of a manual are digitally captured as individual segments in an audio file, or as individual “snippets” of audio data. The digitized audio instructions are included as part of the application software and will be loaded into computer memory 16 upon installation and execution of this software.

The computer 11 also has a voice recognition program or software 17 for receiving and interpreting an audio command signal from the microphone 13 of the headset 10. The voice recognition program 17 determines the type of “command signal” received, for example, which of a series of commands selected from the group “start”, “next”, “back”, “repeat” and “skip” and delivers the interpreted result to an application software 18 in the computer 11.

Depending upon the command signal received, the application software 18 selects the audio instruction to be emitted from the memory 16.

The computer 11 also has a playback converter 19, as shown, which converts the selected digitized audio instruction to an electrical signal in a format compatible with the IEEE 802.15 wireless transceiver 15. This resultant data is then transmitted from the transceiver 15 to the wireless headset 10 where the signal is converted back to audio.

The computer 11 allows the user to step through the digitized audio manual at his/her own pace to the use of the voice recognition program using the set of key words.

One example of use of the invention would be for cookbooks or recipes. The recipe would be captured as a sequence of audio instructions that would be maintained in the memory 16 of the computer 11. The separate software application 18 resident and running on the computer 11 will integrate the voice recognition software 17 and access the audio file upon receipt of an audio keyword from the user 12 via the wireless headset 10.

By way of example, the recipe would be loaded and upon receipt of the keyword “start” spoken into the wireless headset 10 and interpreted by the voice recognition program 17, the first segment of the audio file would be played back to the user 12 over the headset 10. This first instruction could be, for example, the first ingredient that the user 12 would need to prepare for the recipe. The program would then temporarily pause and wait for further audio instruction from the user 12.

Once the user 12 has retrieved the first ingredient, the user 12 would say, for example “next” which would result in the playing back of the second audio instruction. The user 12 is now completely free to stay focused on making the recipe without the need to refer back and forth to the previously textual recipe. The program provides additional keywords that allow the user to repeat, backup, skip instructions or to restart as desired.

The wireless headset 10 enables a user to move about without being hindered by a cable.

The voice recognition program 17 could be one of many off-the-shelf packages supplied by several different companies, for example, IBM's ViaVoice Voice Recognition Software. This voice recognition software runs as an application under the operating system of the computer and has a purpose to convert the audio information into equivalent text format which is then further processed by the software application 18 of the computer as a character string.

The software application 18 is a custom application written in one or more computing languages available, for example, Visual Basic or Visual C# but is not limited to these. This application will integrate the voice recognition software 17 with the digitized audio instructions which represent the instruction manual. The application 18 will also run on the computer under the operating system of the computer, for example but not limited to, Microsoft's Windows XP. The application 18 receives its input from the voice recognition software 17 and could be in the form of a character string selected among one of several keywords. If the input is not one of the recognized keywords, the input is rejected. If the input is recognized, it will access one of the stored audio segments in a manner consistent with the interpreted command and convert this in the converter 19 to a form suitable for transmission over the wireless link 15 to the headset 10. The headset 10 converts this information back to audio form which is then heard by the user through the ear piece receiver 14.

FIG. 2 illustrates a high level view of the hardware and software as it would be used in a typical application. As an example, the IEEE 802.15 Bluetooth wireless front end 15 interfaces to the computer 11 and outputs its received audio information (i.e. the “command signal”) to the voice recognition software 17.

The application software 18 is responsible for configuring the proper connections between the Bluetooth front end 15 and the voice recognition software 17 via the operating system of the computer.

The voice recognition software 17 is programmed to recognize keywords from a predetermined set as described above. Upon successful reception of a keyword, the control portion of the application software 18 takes an action commensurate with the received keyword. The audio instruction is then directed via the converter 19 to the Bluetooth wireless port (not shown) where it is transmitted back to the user and converted to an audio signal heard through the ear piece receiver 14 of the headset 10.

The digitized audio instructions may exist on any mass storage medium, for example, the hard drive of a computer, a CDROM disk and the like.

The invention thus provides a technique that allows a user to follow a recipe or a set of assembly instructions in a hands free manner via audible command instructions.

The invention also has the capability to time events, for example, the baking duration of a recipe whereby the computer 11 will start an internal timer (not shown) and will emit a signal indicating the expiration of that time on the timer to the user via the wireless headset 10.

Various modifications may be made in the system of the invention. For example, along with the audio instructions, a fixed image can be displayed as a reference for a particular segment or part of the instruction sequence. For example, a complex assembly diagram can be accompanied by several images which can be displayed at the appropriate time along with the audio instructions. Another variant is a checklist where the audio instructions comprise actions on a checklist. As the individual actions are completed, the user can say “check” for example which would effectively remove the action from the list, as would be done for a checklist.

Another application for this invention would be the ability to have, for example, a number of individual pocket PCs (these are literally hand held PDA sized PCs with considerable processing power). Each of these pocket PCs would have a wireless interface to a central computer. A “master” task list would be provided where a subset of the tasks are grouped together and downloaded to a particular pocket PC where they appear as the already described instruction manual. The master task list is broken down into several groups of tasks which are distributed in real-time to several individual pocket PCs, where they are acted upon by a group of individuals. This would be a way for a large complex task to be subdivided down in to many smaller tasks and executed separately by several individuals.

What is claimed is:

1. A voice interactive instruction system comprising
a head set including a microphone for receiving a spoken command from a user and emitting an electrical command signal therefrom in response to said spoken command and a receiver for receiving and converting electrical signals into audible signals; and
a computer having a memory for storing a series of digitized audio instructions, a transceiver for receiving a command signal from said microphone, a voice recognition program for receiving and interpreting said command signal to determine the command signal received from a series of commands, application software for selecting an audio instruction from said memory in dependence on the command signal received and a playback converter for converting a selected digitized audio instruction into an electrical signal for transmission to said receiver in said head set.

2. A voice interactive instruction system as set forth in claim 1 wherein said digitized audio instructions are arranged in chronological order.

3. A voice interactive instruction system as set forth in claim 2 wherein said spoken command is selected from the group consisting of “start” and “next” and wherein said application program selects the first of said audio instructions of said series in response to the spoken command “start” and selects the chronologically next audio instruction of said series in response to the spoken command “next”.

4. A voice interactive instruction system as set forth in claim 2 wherein said spoken command is selected from the group consisting of “start”, “next”, “skip”, “repeat” and “back” and wherein said application program selects the first of said audio instructions of said series in response to the spoken command “start”, selects the chronologically next audio instruction of said series in response to the spoken command “next”, skips the chronologically next audio instruction of said series in response to the spoken command “skip”, repeats the chronologically next audio instruction of said series in response to the spoken command “repeat”, and selects the chronologically prior audio instruction of said series in response to the spoken command “back”

5. A voice interactive system as set forth in claim 1 wherein said receiver is an ear piece.

6. A tutorial method comprising the steps of
storing a series of digitized audio instructions in a computer;
converting a spoken command from a user into an electrical command signal;
delivering said electrical command signal to the computer;
selecting one of said audio instructions of said series of digitized audio instructions in dependence on said command signal;
converting said selected audio instruction into an electrical reply signal;
delivering said electrical reply signal from the computer to a receiver on a user; and
converting said reply signal into an audio signal corresponding to said selected audio instruction.

7. A tutorial method as set forth in claim 6 wherein said digitized audio instructions are arranged in chronological order.

8. A tutorial method as set forth in claim 7 wherein said spoken command is selected from the group consisting of “start”, “next” and “end” and wherein said selecting step selects the first of said audio instructions of said series in response to the spoken command “start”, selects the chronologically next audio instruction of said series in response to the spoken command “next” and wherein said selecting step is terminated in response to the spoken command “end”.

9. A tutorial method as set forth in claim 8 wherein said digitized audio instructions are the steps of a baking recipe.

10. A tutorial method as set forth in claim 8 wherein said digitized audio instructions are the steps of a cooking recipe.

11. A tutorial method as set forth in claim 8 wherein said digitized audio instructions are the steps of
an assembly process.
